(19) United States
(12) Patent Application Publication
(10) Pub. No.: US 2019/0294256 A1
(43) Pub. Date: Sep. 26, 2019

(54) INFORMATION PROCESSING APPARATUS AND COMPUTER PROGRAM PRODUCT

(71) Applicant: Fujitsu Client Computing Limited, Kanagawa (JP)

(72) Inventors: Takahisa Kamataki, Kawasaki (JP); Nobuyuki Koike, Kawasaki (JP)

(73) Assignee: Fujitsu Client Computing Limited, Kanagawa (JP)

(21) Appl. No.: 16/439,857

(22) Filed: Jun. 13, 2019

Related U.S. Application Data
(63) Continuation of application No. PCT/JP2017/047390, filed on Dec. 28, 2017.

(30) Foreign Application Priority Data
Jan. 19, 2017 (JP) 2017-007653

(51) Int. Cl. G06F 3/023; G06F 9/4401

(52) U.S. Cl. CPC G06F 3/023; G06F 9/4406

(57) ABSTRACT

An information processing apparatus includes: a first processor that executes processing depending on an input signal; and a second processor that transmits a signal to the first processor based on press-down of a key on a keyboard. When press-down of the key is detected before an operating system of the information processing apparatus is booted by being powered on, the second processor transmits to the first processor a signal that corresponds to processing that is fixed in advance among a plurality of signals associated with the pressed key, and when the press-down of the key is detected after the booting of the operating system of the information processing apparatus, the second processor transmits to the first processor a signal that corresponds to processing that is set by a user among the plurality of signals.

### CROSS-REFERENCE TO RELATED APPLICATIONS

This application is a continuation of PCT International Application No. PCT/JP2017/047390 filed on Dec. 28, 2017, which claims priority from Japanese Patent Application No. 2017-007653 filed on Jan. 19, 2017, the entire contents of which are incorporated herein by reference.

### FIELD

The present disclosure relates to an information processing apparatus and a computer program product.

### BACKGROUND

A physical key to which two different functions are assigned is provided on a keyboard of a personal computer (hereinafter, may be referred to as “PC”) or the like. Specifically, there is a physical key that functions as a key for executing processing that is arbitrarily assigned to each program (hereinafter, may be referred to as “function key”) and also functions as a key for executing processing that is set in advance regardless of programs such as increase/decrease of sound volume (hereinafter, may be referred to as “feature key”). For example, when the key is pressed down alone, it operates as the feature key. When the key and an Fn key are simultaneously pressed down, the key operates as the function key.

The setting for functioning as the feature key or the function key at the time when the key is pressed down alone can be arbitrarily assigned. In recent years, there is known a technique of fixedly assigning different functions between at the time of a BIOS booting and at the time of an OS booting.

Such physical key is often used for a BIOS setting or the like. For example, after power-on of the PC, a user performs the BIOS setting by pressing down a specific function key, such as an “F2” key, in order to display a setting screen of the BIOS during a booting of the basic input output system (BIOS) before the operating system (OS) is booted up.

However, in the above-described technique, user operations may become complicated, and thereby convenience may be lowered. Users frequently assign the function of the feature key, which is often used after the OS is booted up, as the function of a key that is pressed down alone. Thus, in order to perform the BIOS setting, the operation of pressing down both the Fn key and the F2 key should be performed each time, so that convenience may be lowered.

In addition, since the frequency of the BIOS setting is relatively not high, there is a possibility of forgetting the operation to display the BIOS setting screen. In such case, the PC booting is repeated multiple times, and the operation may become complicated.

### SUMMARY

According to one aspect of the present disclosure, an information processing apparatus includes: a first processor configured to execute processing depending on an input signal; and a second processor configured to transmit a signal to the first processor in accordance with press-down of a key on a keyboard, wherein, when press-down of the key is detected before an operating system of the information processing apparatus is booted by being powered on, the second processor transmits, to the first processor, a signal corresponding to processing that is fixed in advance among a plurality of signals associated with the pressed key, and when press-down of the key is detected after the booting of the operating system of the information processing apparatus, the second processor transmits, to the first processor, a signal corresponding to processing that is set by a user among the plurality of signals.

According to the embodiment, lowering of operability can be suppressed.

### BRIEF DESCRIPTION OF THE DRAWINGS

FIG. 1 is an explanatory drawing of an example of an information processing apparatus according to a first embodiment;

FIG. 2 is an explanatory diagram of a hardware configuration example of the information processing apparatus according to the first embodiment;

FIG. 3 is a functional block diagram illustrating a functional configuration of a keyboard controller according to the first embodiment;

FIG. 4 is a table illustrating an example of a keyboard matrix stored in a conversion DB;

FIG. 5 is a table for explaining an example of a setting of an operating mode and an LED indication;

FIG. 6 is a sequence diagram illustrating a processing flow; and

FIG. 7 is a table for explaining an example of a scenario of a user operation.

### DETAILED DESCRIPTION

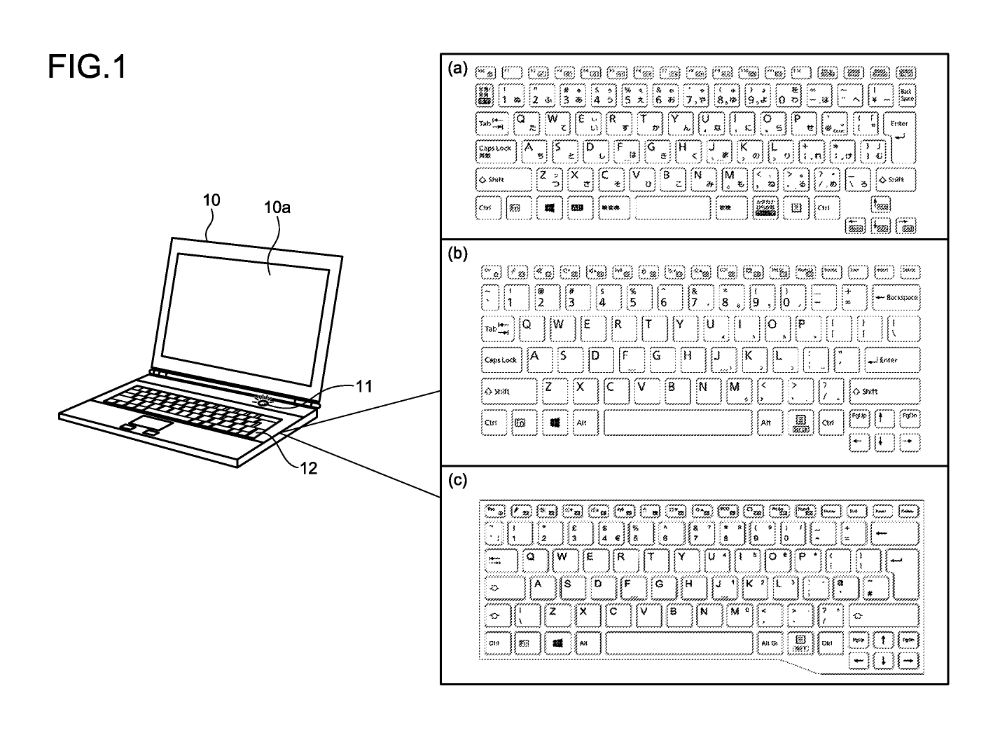

Hereinafter, embodiments of an information processing apparatus and a signal control program disclosed in the present application will be described in detail based on the accompanying drawings. These embodiments are not intended to limit the present disclosure. Furthermore, the non-English texts in FIGS. 1 to 4 are used as a part of the graphical content (i.e., image) and not as letters (i.e., characters).

### First Embodiment

Description of Information Processing Apparatus

FIG. 1 is an explanatory drawing of an example of an information processing apparatus according to a first embodiment. As illustrated in FIG. 1, an information processing apparatus 10 is an example of a computer including a display 10a, a light emitting diode (LED) indicator 11, a keyboard 12, and the like. Although FIG. 1 illustrates a notebook PC, the present disclosure is not limited to this example and can be similarly applied to a server and the like.

In addition, the information processing apparatus 10 is provided with the keyboard 12 that includes a key functioning as the function key and the feature key. Here, any of a keyboard compatible with Japanese input (FIG. 1(a)), a keyboard compatible with the United States (US) (FIG. 1(b)), and a keyboard compatible with the United Kingdom (UK) (FIG. 1 (c)) can be used as the keyboard 12. These types of keyboards are difference from each other in initial settings, for example, a setting of functioning as the function key or as the feature key in the initial stage.

On the information processing apparatus 10, the user can switch the key functions between the function key or the feature key with a predetermined manual operation. For example, when a US-compatible keyboard is used, the functions can be switched by pressing down both an “Fn” key and an “ESC” key. In the present embodiment, press-down of both the “Fn” key and the “ESC” key may be referred to as “Fn+ESC”. In addition, the LED indicator 11 is placed near PC standard LED indicators such as NumLock, CapsLock, and ScrollLock.

Such information processing apparatus 10 receives from a user a setting as to whether the key operates as the feature key or as the function key when the key is pressed down alone. At the time of a booting of a BIOS, the information processing apparatus 10 control the key not to operate according to the setting made by the user but operate as the function key. After a booting of OS subsequent to the booting of the BIOS, the information processing apparatus 10 controls the key to operate as either the feature key or the function key according to the user's setting.

With regard to a key having multiple functions (hereinafter, may be referred to as “single key”), the information processing apparatus 10 includes an operating mode where the key is fixed to the function key (hereinafter, may be referred to as “Func”), an operating mode where the key is fixed to the feature key (hereinafter, may be referred to as “Feat”), and an operating mode where a user is allowed to switch the keys (hereinafter, may be referred to as “Toggle”).

When the state of the operating mode is Func, the information processing apparatus 10 controls the single key to function as the function key at the time of the BIOS booting and also after the OS booting. When the state of the operating mode is Feat, the information processing apparatus 10 controls the single key to function as the feature key at the time of the BIOS booting and also after the OS booting.

On the other hand, when the state of the operating mode is Toggle, the information processing apparatus 10 saves the state (the function key or the feature key) that has been set for the single key by the user. In this case, at the time of the BIOS booting, the information processing apparatus 10 controls the single key to function as the function key regardless of the user's setting. After the OS booting, the information processing apparatus 10 controls the single key to function as either the function key or the feature key depending on the user's setting.

In this manner, the information processing apparatus 10 is able to allow the user to switch functions of the single key and also able to fix the function depending on the state of the information processing apparatus 10. Thus, lowering of operability can be suppressed.

Hardware Configuration

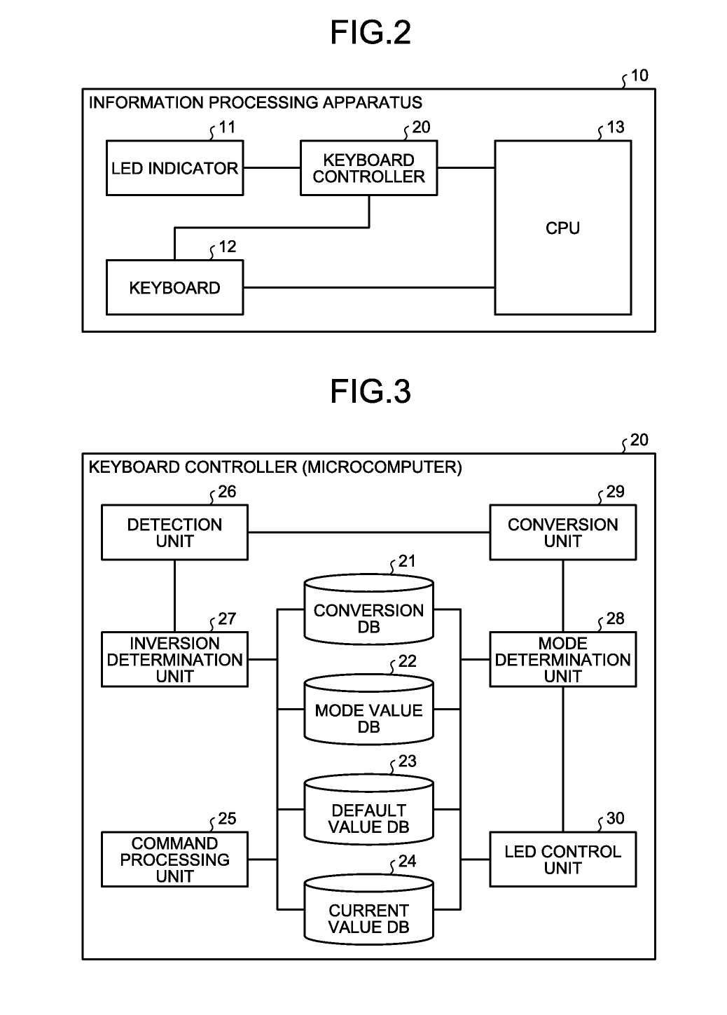

FIG. 2 is an explanatory diagram of a hardware configuration example of the information processing apparatus 10 according to the first embodiment. As illustrated in FIG. 2, the information processing apparatus 10 includes the LED indicator 11, the keyboard 12, a central processing unit (CPU) 13 (first processor), and a keyboard controller 20 (second processor), all of which are interconnected by using a bus or the like.

The LED indicator 11 is an example of a light-emitting device that lights an LED. The keyboard 12 is an example of an input device including a single key that is capable of operating a plurality of functions. The CPU 13 is a processing unit that controls the entire information processing apparatus 10, and it executes an input operation or the like that is received by the keyboard 12. The keyboard controller 20 is a processing unit that controls the operating mode of the keyboard, and it may be referred to as a microcomputer 20 in the present embodiment. Although not illustrated, the BIOS and the like are executed on a mother board.

The keyboard 12 outputs a scan code to the keyboard controller (microcomputer) 20, and by using general purpose input/output (GPIO), outputs keyboard information related to the keyboard 12 to the CPU 13.

The keyboard controller (microcomputer) 20 acquires the scan code from the keyboard 12, and converts this into a key code to output the key code to the CPU 13. In addition, the microcomputer 20 transmits a signal to the LED indicator 11 by using the GPIO to control turn on/off of the LED. The CPU 13 and the microcomputer 20 exchange a control command so as to control the state of the keyboard 12, and the keyboard 12 is controlled as to in which mode it is operated.

Functional Configuration

FIG. 3 is a functional block diagram illustrating a functional configuration of the keyboard controller 20 according to the first embodiment. As illustrated in FIG. 3, the keyboard controller 20 includes a conversion DB 21, a mode value DB 22, a default value DB 23, a Current value DB 24, a command processing unit 25, a detection unit 26, an inversion determination unit 27, a mode determination unit 28, a conversion unit 29, and an LED control unit 30.

The conversion DB 21, the mode value DB 22, the default value DB 23, and the Current value DB 24 are stored on a storage area of a memory, such as a flash memory, in the microcomputer 20. In addition, the detection unit 26, the inversion determination unit 27, the mode determination unit 28, the conversion unit 29, and the LED control unit 30 are examples of electronic circuitry included in the microcomputer 20 or examples of processing executed by the microcomputer 20.

The conversion DB 21 is a database for storing a keyboard matrix that is a table used for converting the scan code into the key code. Specifically, the conversion DB 21 varies depending on the keyboard type such as Japan, US, or UK, and it stores a table of keys that are changed according to each operating mode of Func or Feat. By storing each keyboard matrix corresponding to each keyboard type and setting information on enabled/disabled, it is possible to identify a table to be used. In addition, a keyboard matrix received from the command processing unit 25, which will be described later, can also be stored in the conversion DB 21.

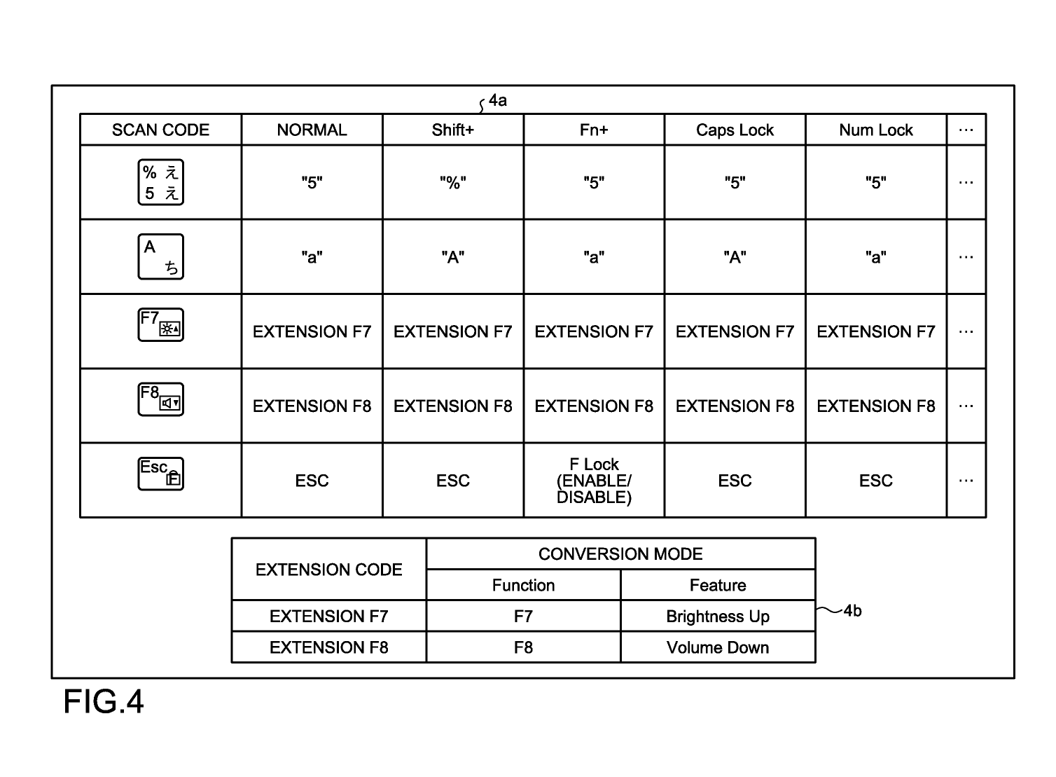

FIG. 4 is a table illustrating an example of the keyboard matrix stored in the conversion DB 21. As illustrated in FIG. 4, the conversion DB 21 stores a matrix table 4a in which a scan code and a key code are associated with each other. The matrix table 4a forms a matrix-like pattern with keyboard states and key combinations.

The “scan code” is a code that is physically assigned to each key of the keyboard 12. The “key code” is a code to be given to the CPU 13, which is information specifying input content or required processing. The “keyboard state” represents a state such as CapsLock or NumLock, and the “key combination” represents a key operation such as “Shift+(key)” or “Fn+(key)”.

In addition, as illustrated in FIG. 4, the conversion DB stores a conversion table 4b in which an “extension code” and a “conversion mode (Function, Feature)” are associated with each other. The “extension code” is a scan code of the single key that is a control target in the present embodiment. The “conversion mode” indicates states determined by operating modes set in each of the mode value DB 22, the default value DB 23, and the Current value DB 24. “Func” is used at the time of a conversion mode that causes a key to function as the function key, and “Feat” is used at the time of a conversion mode that causes a key to function as the feature key.

The example of FIG. 4 represents that, “5” is output as the key code when a scan code “5” is pressed down alone, and “%” is output as the key code when both “Shift” and the scan code “5” are pressed down.

In addition, when both “Shift” and a scan code “F7” are pressed down, “extension F7” is selected. With regard to “extension F7”, when the conversion mode is “Func”, “F7” is output as the key code, and when the conversion mode is “Feat”, “Brightness Up” is output as the key code.

The mode value DB 22 is a database for storing an operating mode of the microcomputer 20. Specifically, the mode value DB 22 stores a parameter of “Func”, “Feat”, or “Toggle”. “Func” indicates a function-fixed state. In this state, when any key among F1 to F12 is pressed, a function key is input according to the pressed key. “Feat” indicates a feature-fixed state. In this state, when any key among F1 to F12 is pressed, a feature key such as “increase the sound volume” is input. “Toggle” indicates that a state saved in the Current value DB 24 is set as the operating mode. In other words, the mode value DB 22 stores mode information indicating whether to allow the user to change the operating mode of the keyboard 12.

The default value DB 23 is a database for storing fixed information related to an operating mode that is fixed to each keyboard type. The default value DB 23 stores an operating mode that is the standard of the information processing apparatus 10. The stored information is used for turn-on control of the LED indicator 11. Specifically, the default value DB 23 stores a parameter of any of “No LED”, “Func”, and “Feat””. “No LED” represents the state where the LED indicator 11 remains constantly turned off. “Func” represents that the function mode is set as the standard. “Feat” represents that the feature mode is set as the standard.

The Current value DB 24 is a database for storing user setting information related to an operating mode set by the user. The Current value DB 24 stores an operating mode to be applied at the time of the Toggle mode. The stored information is switched by a toggle operation of the keyboard. Specifically, the Current value DB 24 stores “Func” when the function mode is selected by the toggle operation of the user, and also stores “Feat” when the feature mode is selected by the toggle operation of the user.

The command processing unit 25 is a processing unit that transmits/receives a command between the CPU 13, the BIOS, and the like, and executes processing in accordance with the received command. Specifically, the command processing unit 25 sets a value for each DB of the conversion DB 21, the mode value DB 22, the default value DB 23, and the Current value DB 24, at the time of an initial booting or rebooting of the information processing apparatus 10. A conversion mode to be used in the conversion table 4b, which is stored in the conversion DB 21, is determined in accordance with the information stored here.

For example, when the information processing apparatus 10 is powered on, and the setting of fixing the operation mode is not performed, the command processing unit 25 sets “Func” for the mode value DB 22. The command processing unit 25 sets “Func” for the mode value DB 22 when the setting of fixing the operating mode to “Func” is performed, and sets “Feat” for the mode value DB 22 when the setting of fixing the operating mode to “Feat” is performed.

Subsequently, the command processing unit 25 sets a keyboard matrix corresponding to the keyboard type given from the BIOS, for the conversion DB 21. Then, the command processing unit 25 determines a default operating mode “Func/Feat” depending on the keyboard type, and sets the determined operating mode for the default value DB 23 and the Current value DB 24.

Furthermore, after the OS booting, the command processing unit 25 determines whether the OS is compliant with the toggle operation. When the OS is compliant with the toggle operation, the command processing unit 25 changes the mode value DB 22 to “Toggle”. In this manner, a change of the operating mode by the user is enabled after the OS booting. On the other hand, when the OS is not compliant with the toggle operation, the command processing unit 25 does not perform a change on the mode value DB 22, and maintains the setting at the time of the booting.

The detection unit 26 is a processing unit that detects a scan code to be output when the keyboard 12 is operated. Specifically, the detection unit 26 determines whether the input scan code is a scan code that indicates switching of the operating mode. When the scan code does not indicate switching of the operating mode, the detection unit 26 outputs the input scan code to the conversion unit 29. When the scan code indicates switching of the operating mode, the detection unit 26 outputs a determination request on whether the operating mode is invertible to the inversion determination unit 27.

For example, when a scan code that is set in advance, such as for the “Fn+ESC” keys, is input, the detection unit 26 determines that the scan code indicates switching of the operating mode. The setting of the scan code indicating switching of the operating mode can be arbitrarily changed in accordance with the type and the like of the information processing apparatus 10.

The inversion determination unit 27 is a processing unit that determines whether the operating mode is invertible, and when it is invertible, inverts the operating mode. Specifically, upon receiving the determination request from the detection unit 26, the inversion determination unit 27 acquires the operating mode that is set in the mode value DB 22. Furthermore, when the operating mode set in the mode value DB 22 is other than “Toggle”, the inversion determination unit 27 determines that the operating mode is not invertible, and maintains the operating mode that has been already set.

On the other hand, when the operating mode set in the mode value DB 22 is “Toggle”, the inversion determination unit 27 determines that the operating mode is invertible, and inverts the operating mode. For example, when “Func” is set in the Current value DB 24, the inversion determination unit 27 changes the operating mode stored in the Current value DB 24 to “Feat”. In addition, when “Feat” is set in the Current value DB 24, the inversion determination unit 27 changes the operating mode stored in the Current value DB 24 to “Func”.

The mode determination unit 28 is a processing unit that determines a conversion mode for converting a scan code, based on the operating mode set in the mode value DB 22 and the operating mode set in the Current value DB 24. More specifically, the mode determination unit 28 determines a conversion mode of the matrix of the conversion DB 21 to be used by the conversion unit 29, and notifies the conversion unit 29 of the determined conversion mode.

Specifically, when “Func” is set in the mode value DB 22, the mode determination unit 28 determines that the operation mode is the fixed mode, and determines the conversion mode to be “Func”. Similarly, when “Feat” is set in the mode value DB 22, the mode determination unit 28 determines that the operation mode is the fixed mode, and determines the conversion mode to be “Feat”. On the other hand, when “Toggle” is set in the mode value DB 22, the mode determination unit 28 determines the conversion mode to be the operating mode set in the Current value DB 24.

For example, it is assumed that the command processing unit 25 sets, at the time of the BIOS booting, “Func” in the mode value DB 22 and “Feat” in the default value DB 23 and the Current value DB 24 depending on the type of the keyboard 12. Furthermore, it is assumed that “Func” is changed to “Toggle” in the mode value DB 22 after the OS booting.

In the above case, since “Func” is set in the mode value DB 22 at the time of the BIOS booting, the mode determination unit 28 determines the conversion mode to be “Func” regardless of the setting state of the Current value DB 24. Furthermore, since the mode value DB 22 stores “Toggle” and the Current value DB 24 stores “Feat” after the OS booting, the mode determination unit 28 determines the conversion mode to be “Feat”.

The conversion unit 29 is a processing unit that converts a scan code into a key code to output the key code to the CPU 13. Specifically, the conversion unit 29 refers to each table stored in the conversion DB 21, and converts the scan code into the key code.

An explanation will be given by using the matrix table 4a and the conversion table 4b of the Japanese-compatible keyboard illustrated in FIG. 4 as an example. When a “5” key in the keyboard is pressed down alone, the conversion unit 29 specifies the key code “5” from the matrix table 4a, and outputs this to the CPU 13. When “Shift+a” keys of the keyboard are pressed down, the conversion unit 29 specifies a key code “A” from the matrix table 4a, and outputs this key code to the CPU 13.

In addition, when “Shift+F7” keys of the keyboard are pressed down, the conversion unit 29 specifies the key code “extension F7” from the matrix table 4a. In this regard, the conversion unit 29 specifies a key code corresponding to the “extension F7” by referring to the conversion table 4b of the conversion DB 21. At this time, the key code is specified in accordance with the conversion mode given by the mode determination unit 28. In other words, the conversion unit 29 outputs “F7” to the CPU 13 as the key code when the conversion mode is “Func”, and outputs “Brightness Up” to the CPU 13 as the key code when the conversion mode is “Feat”.

The LED control unit 30 is a processing unit that controls turn-on/off of the LED indicator 11. Specifically, when the operating mode set in the default value DB 23 and the conversion mode determined by the mode determination unit 28 are different, the LED indicator 11 is turned on, and when they are the same, the LED indicator 11 is turned off.

For example, in a state where an operating mode other than “Toggle” is set in the mode value DB 22, the LED control unit 30 turns on the LED indicator 11 when the operating mode set in the default value DB 23 and the operating mode set in the mode value DB 22 are different, and turns off the LED indicator 11 when the respective operating modes are the same.

In addition, in a state where “Toggle” is set in the mode value DB 22, the LED control unit 30 turns on the LED indicator 11 when the operating mode set in the default value DB 23 and the operating mode set in the Current value DB 24 are different, and turns off the LED indicator 11 when the respective operating modes are the same.

State Transition

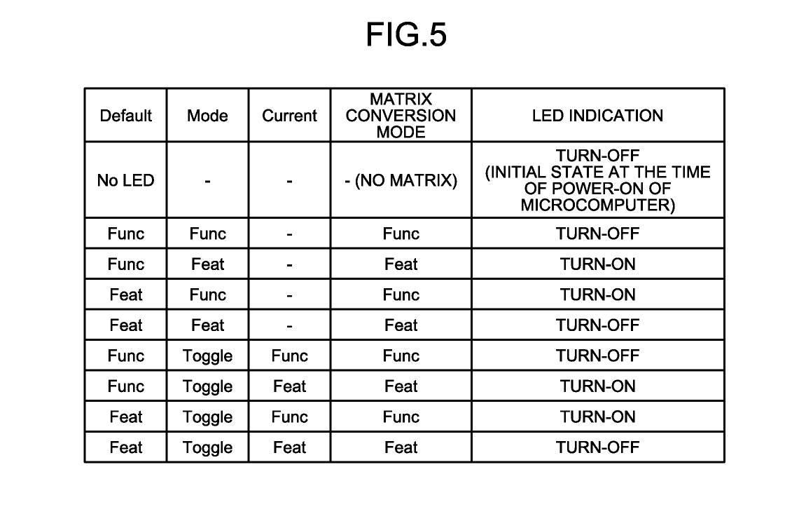

The following gives an explanation on the point that the setting of the conversion mode is changed and turn-on control of the LED is executed depending on the operating mode stored in each DB. FIG. 5 is a table for explaining an example of a setting of an operating mode and an LED indication. In FIG. 5, “Default” indicates the operating mode set in the default value DB 23, “Mode” indicates the operating mode set in the mode value DB 22, and “Current” indicates the operating mode set in the Current value DB 24. In addition, a “matrix conversion mode” is a conversion mode that is determined by the mode determination unit 28, and it indicates a conversion mode to be employed in the conversion table 4b of the conversion DB 21. The “LED indication” indicates the turn-on state of the LED indicator 11. Note that “-” set in FIG. 5 indicates that there is no dependence on a value of that item.

As illustrated in FIG. 5, when the operating mode set in the default value DB 23 is “No LED” being the initial value, the LED control unit 30 turns off the LED indicator 11 regardless of the operating modes set in other DBs. At this time point, the matrix table is not set, and it is the initial state of power-on of the microcomputer 20.

Furthermore, regardless of the operating mode set in the default value DB 23, the mode determination unit 28 determines the conversion mode to be “Func” when the operating mode set in the mode value DB 22 is “Func”. At this time, the LED control unit 30 turns off the LED indicator 11 when the operating mode set in the default value DB 23 is also “Func”, and turns on the LED indicator 11 when the operating mode set in the default value DB 23 is “Feat”.

Similarly, regardless of the operating mode set in the default value DB 23, the mode determination unit 28 determines the conversion mode to be “Feat” when the operating mode set in the mode value DB 22 is “Feat”. At this time, the LED control unit 30 turns off the LED indicator 11 when the operating mode set in the default value DB 23 is also “Feat”, and turns on the LED indicator 11 when the operating mode set in the default value DB 23 is “Func”.

In addition, when the operating mode set in the mode value DB 22 is “Toggle”, the mode determination unit 28 determines the operating mode set in the Current value DB 24 to be the conversion mode regardless of the default value DB 23. Note that the LED control unit 30 turns off the LED indicator 11 when the operating mode set in the default value DB 23 coincide with the conversion mode, and turns on the LED indicator 11 when the operating mode set in the default value DB 23 is different from the conversion mode.

Processing Flow

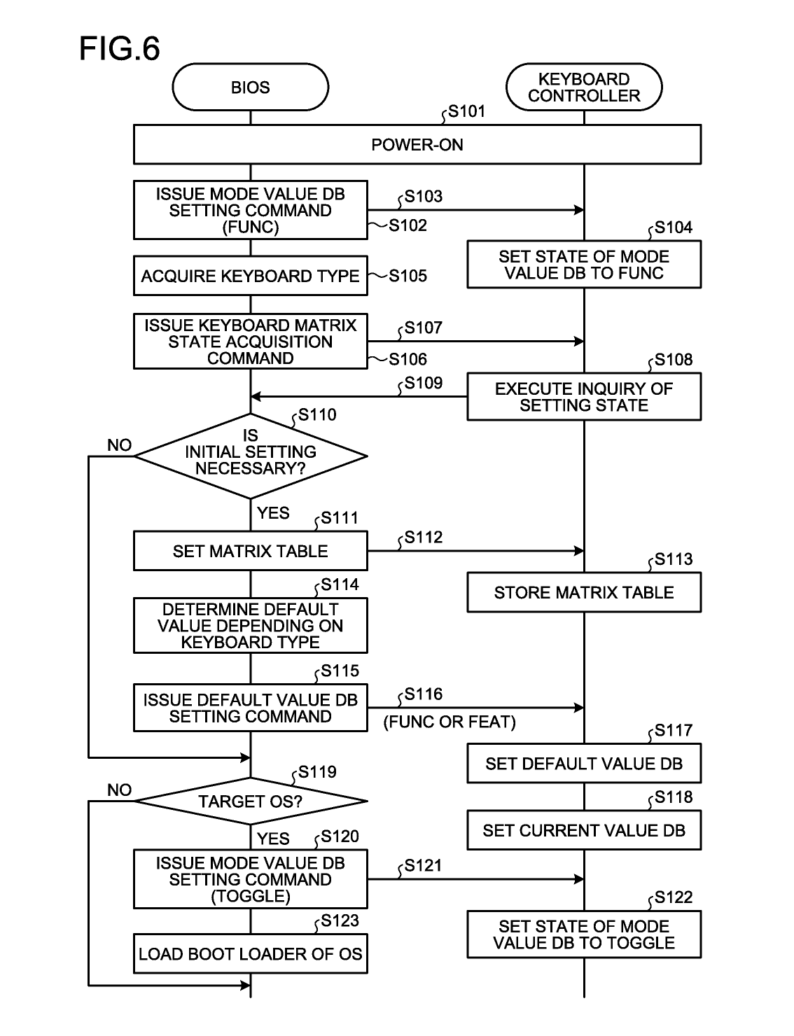

FIG. 6 is a sequence diagram illustrating a processing flow. A flow from the initial booting to the OS booting will be described.

As illustrated in FIG. 6, once powered on (S101), the BIOS issues (transmits) a setting command to set “Func” in the mode value DB 22 to the microcomputer 20 in order to enable only the function key (S102 and S103). Subsequently, the command processing unit 25 of the microcomputer 20 sets “Func” in the mode value DB 22 (S104).

The BIOS acquires the type of the keyboard 12 via the GPIO of the CPU 13 (S105), and issues a command to acquire the state of the keyboard matrix to the microcomputer 20 (S106 and S107). The command processing unit 25 of the microcomputer 20 that received this command executes an inquiry of the setting state, which inquires whether the keyboard matrix has been set (S108 and S109).

When reading of the keyboard matrix has not been executed, and there is a need of an initial setting (Yes at S110), the BIOS selects and sets a keyboard matrix corresponding to the keyboard 12 from each matrix table stored in the BIOS (S111). The BIOS transmits the selected matrix table to the microcomputer 20 (S112). The command processing unit 25 of the microcomputer 20 stores the received matrix table in the conversion DB 21 (S113).

The BIOS determines which of Function and Feature is to be set as the default value (standard) depending on the type of the keyboard 12 (S114). For example, Function becomes the default value in the Japanese keyboard, and Feature becomes the default value in other types of keyboards. Subsequently, the BIOS issues a default setting command that requests for the setting of the default value DB 23, and notifies the microcomputer 20 of the default value (S115 and S116).

The command processing unit 25 of the microcomputer 20 sets the notified default value in the default value DB 23 (S117) and also in the Current value DB 24 (S118).

After that, when the BIOS determines, based on a specific booting device and an OS type, that a target OS is compliant with the toggle operation (Yes at S119), the BIOS transmits a command to change the operating mode of the mode value DB 22 to “Toggle” to the microcomputer 20 (S120 and S121). Subsequently, the command processing unit 25 of the microcomputer 20 sets “Toggle” in the mode value DB 22 (S122). The BIOS loads a boot loader of the OS (S123), and the initial setting is completed.

At the time of an input of a combination of specific keys such as the “Fn+ESC” keys, toggle (between Func and Feat) of the functions is performed. Thus, the toggle operation is kept enabled during the use of the OS after loading the OS (S123). The state of Func or Feat is stored in the microcomputer 20, so that the state returns to the same state as the last time when the mode setting becomes Toggle. Since this operation is completed in the microcomputer 20, it can be implemented without using an application or driver on the OS.

When the initial setting is completed (No at S110), processing from S119 onward is executed. When the OS is not the target OS (No at S119), processing of S123 is executed.

Scenario

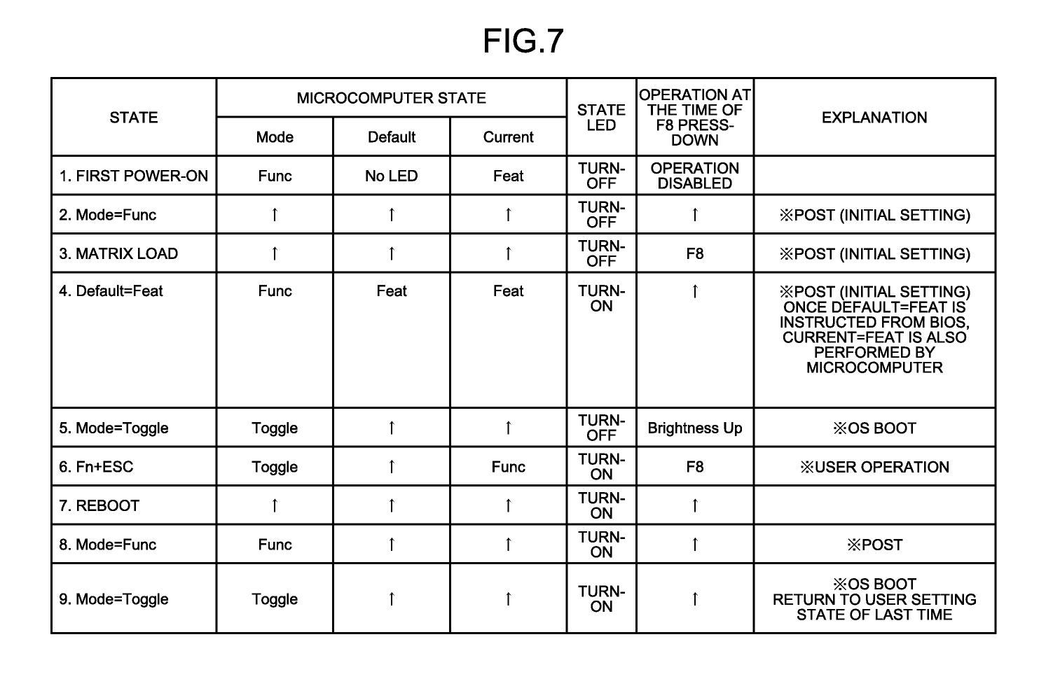

The following describes processing from power-on by a user to occurrence of a keyboard operation with referring to the US-compatible keyboard 12 as an example. The explanation is made with an example in which power-on of the information processing apparatus 10, switching of the operating mode by the user, and a rebooting are executed. FIG. 7 is a table for explaining an example of a scenario of a user operation. Mode and the like illustrated in FIG. 7 are the same as those in FIG. 5. Arrows in FIG. 7 indicate that there is no change.

As illustrated in FIG. 7, when the information processing apparatus 10 is powered on by the user, the initial setting is executed. Specifically, when the initial power-on is executed, the microcomputer 20 turns off the LED indicator 11 because “No LED” is set in the default value DB 23 (Item 1 in FIG. 7). At this time, the keyboard 12 does not operate at all. The explanation is made herein with an example in which “Func” is set for Mode and “Feat” is set for Current as the initial setting. However, the present disclosure is not limited to this case, and the same processing can be performed in any state.

After that, the microcomputer 20 executes the initial setting by a power on self-test (POST) or the like (Items 2, 3, and 4 in FIG. 7). Specifically, the microcomputer 20 sets “Func” for Mode, and sets a keyboard matrix corresponding to the keyboard type for the conversion DB 21. At this time, since Default remains “No LED”, the microcomputer 20 keeps the LED indicator 11 turned off. Subsequently, the microcomputer 20 sets “Feat”, which is the standard of the US-compatible keyboard, as Default. At this time, the microcomputer 20 also sets “Feat” for Current. Since the operating modes of Default and Mode differ from each other, the microcomputer 20 turns on the LED indicator 11. Turn-on of the LED indicator 11 represents that the function key, which is inverse to the standard feature key of the US-compatible keyboard, is the standard operation. Accordingly, by pressing an F8 key at this time point, this key operates as the “F8” key.

Subsequently, at the timing at which the OS is booted up, the microcomputer 20 changes Mode to “Toggle” (Item 5 in FIG. 7). Specifically, the microcomputer 20 changes Mode to “Toggle”, while keeping “Feat” for Default and Current. As a result, Default and Current are in the same operating mode in the state where Mode is “Toggle”. In this case, the microcomputer 20 turns off the LED indicator 11. Turn-off of the LED indicator 11 represents functioning as the standard feature key of the US-compatible keyboard 12. Accordingly, when the user presses the F8 key at this time point, this key operates as the “Brightness Up” key.

When the user operates the “Fn+ESC” keys, the LED indicator 11 is turned on (Item 6 in FIG. 7). Specifically, since switching operation of operating modes is detected, the microcomputer 20 changes Current from “Feat” to “Func”. As a result, Default and Current are in different operating modes in the state of Mode=Toggle. In this case, the microcomputer 20 turns on the LED indicator 11. The turn-on of the LED indicator 11 represents that the US-compatible keyboard 12 functions as the function key. Accordingly, when the user presses the F8 key at this time point, this key operates as the “F8” key.

When the user executes a rebooting of the information processing apparatus 10, the function key (Func) is enabled immediately after the rebooting till the OS booting, and a user setting of the last time is reflected after the OS is booted up (Items 7, 8, and 9 in FIG. 7).

Specifically, once a rebooting occurs, the microcomputer 20 changes Mode to Func while retaining Default and Current. As a result, the microcomputer 20 maintains turn-on of the LED indicator 11 and causes the US-compatible keyboard 12 to function as the function key. Accordingly, when the user presses the F8 key at this time point, this key operates as the “F8” key. After that, when the OS is booted up, the microcomputer 20 changes Mode to Toggle and enables Func of Current set by the user. As a result, Default and Current are in different operating modes in the state of Mode=Toggle. Thus, turn-on of the LED indicator 11 is maintained. More specifically, after Func is forcibly enabled before the OS booting, the OS returns in the state of the operating mode set by the user last time (6 in FIG. 7).

Effects

According to the information processing apparatus 10, even if a user performs a setting of using the feature key, not the function key, it is possible to realize press-down of the function key with only press-down of the single key at the time of a BIOS booting.

In addition, the information processing apparatus 10 can change the behavior concerning function switching of the keyboard 12 depending on the keyboard type. For example, if there are devices for Japan and overseas, and a function key such as the F8 key is intended to be set as the standard in Japan, while a feature key such as volume down is intended to be set as the standard in overseas, it is possible to deal with both shipments by only replacing the keyboard 12. Furthermore, the information processing apparatus 10 can perform function switching without installing a specific application on the OS.

### Second Embodiment

While the example of the present disclosure has been described, the present disclosure may be embodied in a variety of other forms, besides the example described above. Thus, the following describes other examples.

### Indication Example

Although the above-described example gives an explanation on the example of the LED indication, the present disclosure is not limited to this, and other indication methods, such as displaying a message on a display, can also be employed.

Program

The information processing apparatus 10 operates as an information processing apparatus that executes a signal control method by reading and executing a program. In other words, the information processing apparatus 10 executes a program that executes the same functions as the command processing unit 25, the detection unit 26, the inversion determination unit 27, the mode determination unit 28, the conversion unit 29, and the LED control unit 30. As a result, the information processing apparatus 10 can execute a process that executes the same functions as the command processing unit 25, the detection unit 26, the inversion determination unit 27, the mode determination unit 28, the conversion unit 29, and the LED control unit 30. The program referred to in other example than this example is not limited to being executed by the information processing apparatus 10. For example, the present disclosure can also be applied to a case in which the program is executed by another computer or server, or a case in which such computer and server cooperate to execute the program.

The foregoing program can be distributed through a network such as the Internet. In addition, this program can be stored on a recording medium that is readable by a computer such as a hard disk, flexible disk (FD), CD-ROM, magneto-optical disk (MO), or digital versatile disc (DVD), and can be executed by being read from the recording medium by the computer.

System

Information including processing procedures, control procedures, specific names, and various data and parameters shown in the above document and the drawings can be arbitrarily changed unless otherwise specified.

In addition, the respective constituent elements of the respective devices are illustrated functionally and conceptually, and they are not necessarily physically configured as illustrated. More specifically, specific forms of dispersion/integration of the respective devices are not limited to those that are illustrated. In other words, all or part thereof can be configured by being functionally or physically dispersed/integrated in an arbitrary unit, in accordance with various loads, usage conditions, and the like. Furthermore, with regard to the respective processing functions performed in the respective devices, all or any part thereof may be implemented with a CPU and a program that is analyzed and executed by the CPU, or may be implemented as hardware by a wired logic.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

What is claimed is:

1. An information processing apparatus comprising:
a first processor that executes processing depending on an input signal; and
a second processor that transmits a signal to the first processor based on press-down of a key on a keyboard, wherein,
when the press-down of the key is detected before an operating system of the information processing apparatus is booted by being powered on, the second processor transmits to the first processor a signal that corresponds to processing that is fixed in advance among a plurality of signals associated with the pressed key, and
when the press-down of the key is detected after the booting of the operating system of the information processing apparatus, the second processor transmits to the first processor a signal that corresponds to processing that is set by a user among the plurality of signals.

2. The information processing apparatus according to claim 1, wherein the second processor:
includes a memory that stores fixed information related to an operating mode that is fixed for each type of the keyboard and stores user setting information related to an operating mode that is set by the user,
specifies, based on the fixed information, an operating mode that corresponds to a type of the keyboard connected to the second processor and transmits a signal that corresponds to the specified operating mode to the first processor, and
transmits a signal that corresponds to an operating mode that is set in the user setting information to the first processor.

3. The information processing apparatus according to claim 2, wherein
the memory further stores mode information that represents whether or not to allow a user to change an operating mode of the keyboard, and
the second processor further:
transmits a signal that corresponds to an operating mode that is specified from a type of the keyboard to the first processor regardless of information that is set in the mode information,
transmits the signal that corresponds to the operating mode specified from the type of the keyboard to the first processor when the change of the operating mode is not allowed, and
transmits the signal that corresponds to the operating mode set in the user setting information to the first processor when the change of the operating mode is allowed.

4. A non-transitory computer readable medium storing computer program product including programmed instructions embodied therein, the instructions are executed by an information processing apparatus that includes a first processor that executes processing depending on an input signal and a second processor that transmits a signal to the first processor based on press-down of a key on a keyboard, the instructions causing the second processor to perform:
transmitting to the first processor, when the press-down of the key is detected before an operating system of the information processing apparatus is booted by being powered on, a signal that corresponds to processing that is fixed in advance among a plurality of signals associated with the pressed key; and
transmitting to the first processor, when the press-down of the key is detected after the booting of the operating system of the information processing apparatus, a signal that corresponds to processing that is set by a user among the plurality of signals.
